(19) United States
(12) Patent Application Publication
(10) Pub. No.: US 2019/0073235 A1
(43) Pub. Date: Mar. 7, 2019

(54) NETWORK SYSTEM, PATCH FILE APPLICATION METHOD, AND RECORDING MEDIUM

(71) Applicant: NEC Corporation, Minato-ku, Tokyo (JP)

(72) Inventor: Yoshihiko HOSHINO, Tokyo (JP)

(73) Assignee: NEC Corporation, Minato-ku, Tokyo (JP)

(21) Appl. No.: 16/084,651

(22) PCT Filed: Apr. 14, 2017
(86) PCT No.: PCT/JP2017/015222

§ 371 Date: Sep. 13, 2018

(30) Foreign Application Priority Data
Apr. 21, 2016 (JP) 2016-085053

(51) Int. Cl. G06F 9/455; G06F 8/654; H04L 12/24

(52) U.S. Cl. CPC G06F 9/45558; G06F 8/654; G06F 2009/45591; G06F 2009/45595; G06F 2009/45575; H04L 41/0893

(57) ABSTRACT

In order to provide a network system that contributes to efficient expansion of an image file used in the instantiation of a virtualized network function (VNF), this network system provides a network functions virtualization infrastructure (NFVI) that provides the execution infrastructure of a VNF implemented by software operating on a virtual machine and virtualized, an element management system (EMS) that corresponds to the VNF, an NFV orchestrator (NFVO) that realizes a network service on the NFVI, and a VNF manager (VNFM) that manages the lifecycle of the VNF. One of the EMS, the NFVO and the VNFM provide a patch file used in updating the VNF.

### TECHNICAL FIELD

The present invention relates to a network system, a patch file application method, and a recording medium.

### BACKGROUND ART

Network functions virtualization (NFV) is known (for example, refer to NPLs 1 and 2). NFV realizes functions of network apparatus or the like by software. NFV is realized by using a virtual machine (VM) installed on a virtualization layer, such as a hypervisor (HV) on a server.

FIG. 8 is a drawing in which FIG. 4 in Chapter 7 of NPL 2 is simplified. With reference to FIG. 8, the following explains an overview of a network configuration of a VNF environment.

A virtualized network function (VNF) 22 is related to an application or the like operating on a virtual machine (VM) on a server, and realizes a network function by software. A management function such as an element management system (EMS) 23 is provided for each VNF 22. The EMS 23 is also referred to as an element manager (EM).

A network functions virtualization infrastructure (NFVI) 21 is a basis on which a hardware resource can be flexibly handled as a virtualized hardware resource. Hardware resources include computing, storage, network function, or physical machines (servers). Virtualized hardware resources includes virtualized computing, virtualized storage, or virtualized network which are virtualized on a virtualized layer such as a hypervisor.

A NFV Orchestrator (NFVO) 11 in a NFV management & orchestration (NFV-MANO) 10 performs the following processing. That is, the processing is an orchestration of resources of the NFVI 21, and lifecycle management of network service (NS) instances. Note that NS instances include instantiation, scaling, termination, and update of NS instances.

A VNF manager (VNFM) 12 performs lifecycle management of VNF instances and event notification. The lifecycle management of VNF instances is, for example, instantiation, update, query, scaling, and termination.

A virtualized infrastructure manager (VIM) 13 performs the following processing. That is, the processing includes resource management of computing, storage, and network of the NFVI 21, fault monitoring of the NFVI 21, and resource monitoring of the NFVI 21.

In OSS/BSS 30, operations support system (OSS) is a collective name of a system (such as apparatus, software, and setup) that is required by a communication operator (carrier) to construct and operate a service, for example. Business support system (BSS) is a collective name of an information system (such as apparatus, software, and setup) used by a communication operator (carrier) for billing or invoicing of usage fee or the like, and client handling.

Note that PTLs 1 and 2 are literatures related to the present invention. PTL 1 discloses a technique that is related to NFV and the like.

PTL 2 discloses a technique that is related to an image file for managing a client terminal and the like.

### CITATION LIST

### Patent Literature

[PTL 1] Japanese Patent Application Publication 2015-194949
[PTL 2] Japanese Patent Application Publication 2013-186793

### Non Patent Literature

[NPL 1] ETSI GS NFV-MAN 001 V1.1.1 (2014-12), “Network Functions Virtualisation (NFV); Management and Orchestration”, [online], [Searched on Apr. 5, 2016], on the Internet (URL:http://www.etsi.org/deliver/etsi_gs/NFV-MAN/001_099/001/01.01.0 1_60/gs_NFV-MAN001v010101p.pdf)
[NPL 2] ETSI GS NFV 002 V1.2.1 (2014-12), “Network Functions Virtualisation (NFV); Architectural Framework” [online], [Searched on Apr. 8, 2016], on the Internet (URL:http://www.etsi.org/deliver/etsi_gs/NFV/001_099/002/01.02.01_60/gs_NFV002v010201p.pdf)

### SUMMARY OF INVENTION

### Technical Problem

Each disclosure of the above prior arts is incorporated herein by reference. The following analysis has been done by the inventors of the present invention.

The above-described NFVO 11, VNFM 12, VIM 13, and the like are functional entities for managing the network system. A virtual machine and a VNF are generated on a physical machine (PM) by being controlled by these functional entities.

As illustrated in FIG. 9, a plurality of physical machines are collectively deployed at a regional base that constitutes a part of the network system. The VIM 13 is deployed for the plurality of physical machines. In addition, a service assistance mechanism such as an OSS/BSS 30 and a management mechanism such as an NFVO 11 and a VNFM 12 are usually collectively deployed in the central base. The management mechanism collectively deployed in the central base performs entire resource management and the like across a plurality of regional bases (a plurality of VIMs).

In a network system of a VNF environment as illustrated in FIG. 9, an image file required for instantiation of a VNF 22 is provided to a VIM 13 of a regional base from the NFVO 11 of the central base. The VIM 13 in each regional base provides the NFVI 21 with the image file provided. Then, the VNF 22 is instantiated, based on the image file.

More specifically, as illustrated in FIG. 10, the VIM 13 deployed in each regional base (or to be more accurate, a server in which the VIM 13 is installed) acquires an image file from the central base. Thereafter, a virtual machine is generated by allocating resources, and the VNF 22 is instantiated by transferring the image file to the hard disk drive (HDD) or the like allocated to the virtual machine.

In this way, the image file used in instantiation of the VNF 22 is expanded in regional bases that are distributed nationwide from the central base. However, expansion of an image file consumes time and can pose issues in actual operation.

The above-mentioned image file contains data that is required for instantiation of the VNF 22. Specifically, the above-mentioned image file contains program data concerning an operating system (OS), middleware (MW), and an application (APL) to be executed on the virtual machine. It is not preferable to transmit such a large-sized image file from a central base to a regional base, every time when the specification of VNF 22 is changed or software constituting the VNF 22 is corrected for a fault, for the following aspects. The aspects includes utilization efficiency of network resources and time consumed for expansion of an image file. Especially, in an environment in which minor update of the VNF 22 is frequently made, the above issues are more conspicuous.

An objective of the present invention is to provide a network system, a patch file application method, and a recording medium, which contribute to efficient expansion of an image file to be used in instantiation of a VNF.

### Solution to Problem

A network system according to first aspect of the present invention includes:

a network function virtualization infrastructure (NFVI) that provides an execution basis for a virtual network function (VNF) installed and virtualized by software operating on a virtual machine;

an element management system (EMS) that relates to the VNF;

a NFV orchestrator (NFVO) that realizes a network service on the NFVI; and

a VNF manager (VNFM) that manages a lifecycle of the VNF, wherein

any one of the EMS, the NFVO, and the VNFM provides the NFVI with a patch file used for updating the VNF.

A patch file application method according to second aspect used in a network system includes:

a network function virtualization infrastructure (NFVI) that provides an execution basis for a virtual network function (VNF) installed and virtualized by software operating on a virtual machine;

an element management system (EMS) for the VNF;

a NFV orchestrator (NFVO) that realizes a network service on the NFVI; and

a VNF manager (VNFM) that manages a lifecycle of the VNF, wherein

the patch file application method includes:

providing the NFVI with a patch file used for updating the VNF, by any one of the EMS, the NFVO, and the VNFM; and

performing instantiation of the VNF by using the patch file provided.

A recording medium according to third aspect of the present invention records a program therein to be computer readable. The program is executed by a computer that controls a Virtual Network Function manager (VNFM) managing a lifecycle of a virtual network function (VNF) that is installed and virtualized by software operating on a virtual machine. The program is to execute a process of providing, with a patch file used for updating the VNF, a network function virtualization infrastructure (NFVI) that provides an execution basis for the VNF.

Note that the program may be recorded in a computer-readable recording medium. The medium may be a non-transient medium such as a semiconductor memory, a hard disk, a magnetic recording medium or magnetic optical medium. The present invention may be realized as a product of computer program.

### Advantageous Effects of Invention

Based on each aspect of the present invention, a network system, a patch file application method, and a recording medium, which contribute to efficient expansion of an image file to be used in instantiation of a VNF, are provided.

### BRIEF DESCRIPTION OF DRAWINGS

FIG. 1 is a drawing to explain an overview of an example embodiment.

FIG. 2 is a drawing illustrating an exemplary schematic configuration of a network system according to a first example embodiment.

FIG. 3 is a block diagram illustrating an exemplary hardware configuration of a physical machine according to the first example embodiment.

FIG. 4 is a block diagram for explaining a function of the network system according to the first example embodiment.

FIG. 5 is a drawing illustrating an operation of the network system according to the first example embodiment.

FIG. 6 is a sequence diagram illustrating an exemplary operation of the network system, concerning update of a VNF.

FIG. 7 is a drawing for explaining expansion of an image file according to the first example embodiment.

FIG. 8 is a drawing in which FIG. 4 in Chapter 7 of NPL 2 is simplified.

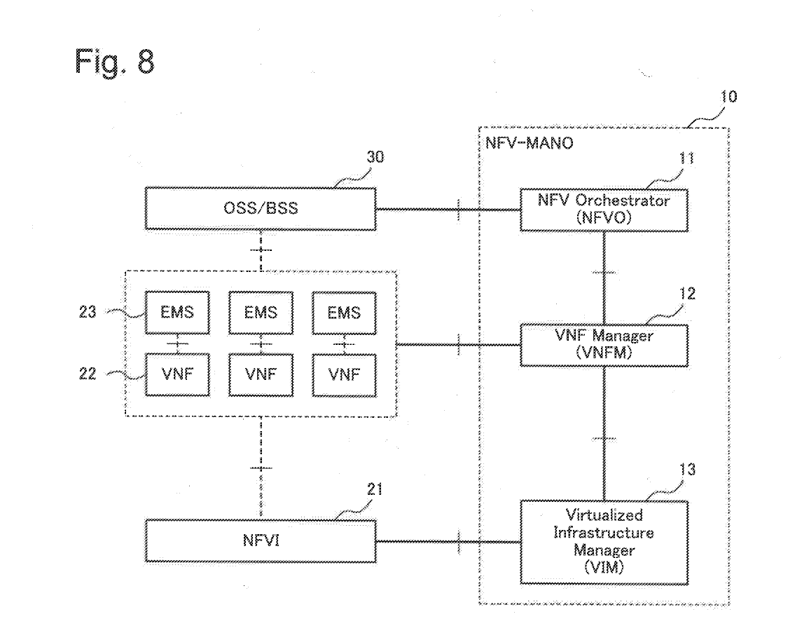

FIG. 9 is a drawing illustrating an exemplary configuration of a network system in a VNF environment.

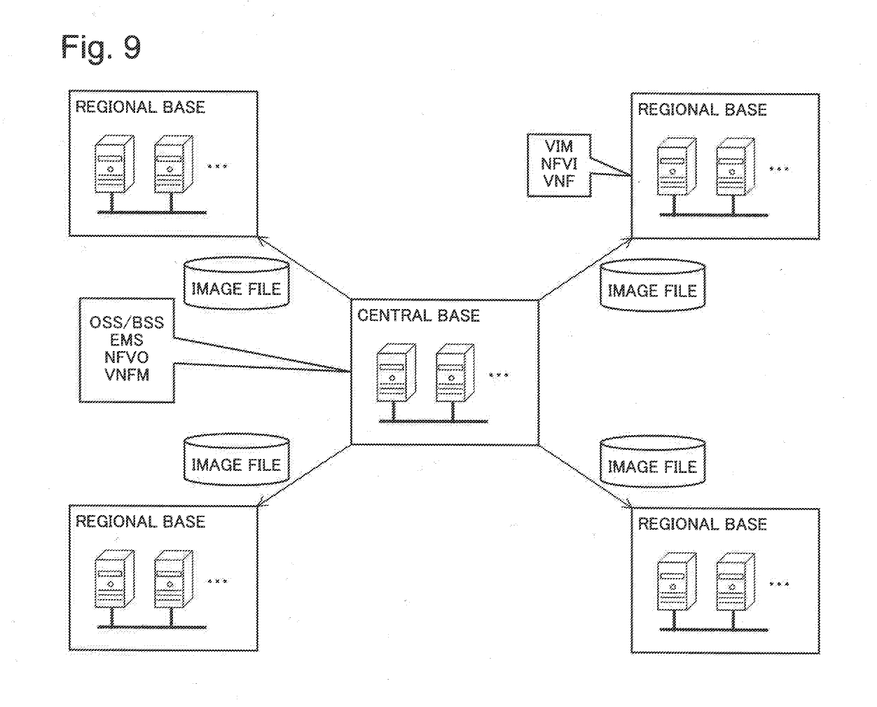

FIG. 10 is a drawing for explaining expansion of an image file.

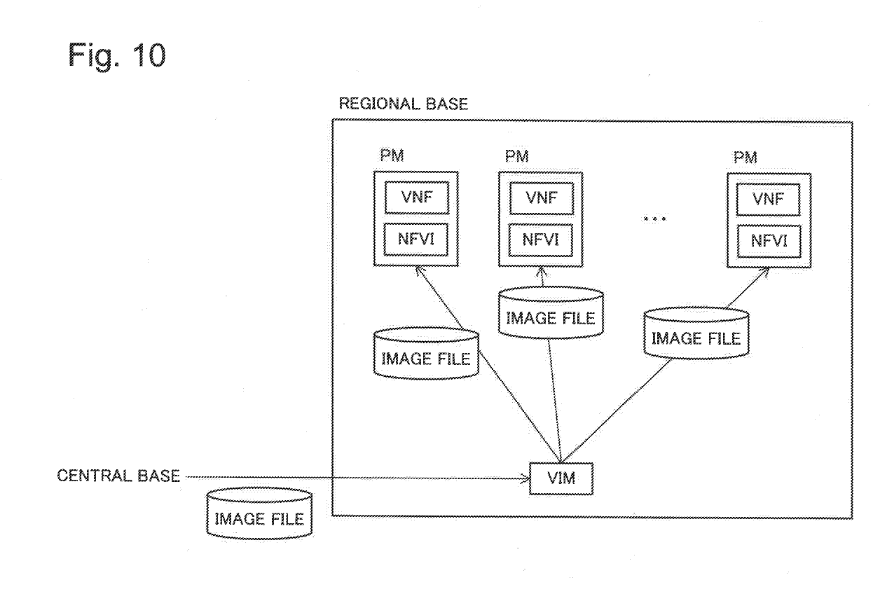

### EXAMPLE EMBODIMENT

First, an overview of an example embodiment is explained. Note that drawing reference numerals used in this overview are assigned to each element as an example, for convenience purpose to facilitated understanding. The description of this overview does not intend any limitation.

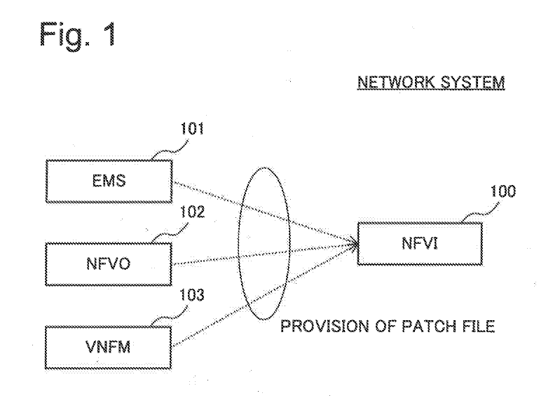

FIG. 1 is a drawing to explain an overview of an example embodiment.

A network system according to an example embodiment includes a NFVI 100, an EMS 101, a NFVO 102, and a VNFM 103. The NFVI 100 is installed, based on software operating on a virtual machine, and provides an execution basis for a virtual network function (VNF). The EMS 101 relates to the VNF. The NFVO 102 realizes a network service on the NFVI 100. The VNFM 103 manages a lifecycle of the VNF. Any one of the EMS 101, the NFVO 102, and the VNFM 103 provides the NFVI 100 with a patch file to be used in update of the VNF.

The network system according to the above-described example embodiment directly provides the NFVI 100 with a patch file required to change the VNF, from an apparatus in the central base in which the EMS 101 or the like is deployed. Based on this operation, because a small-sized image file is transferred without passing through any apparatus (VIM of the regional base; not illustrated in FIG. 1), the network system can shorten the time which is required in the network and required for healing or the like of the VNF. That is, in a NFV-MANO which controls a VNF being a virtualized node, it is possible to efficiently expand an image file (a file to launch a VNF) from the NFV-MANO when applying VNF patch. In other words, at the time of minor update, which is frequently performed, for patch application, a partial image file (e.g., only application data) limited to a portion to which a patch is applied is directly provided to the VNF, via the EMS 101 and the VNFM 103. This operation can improve operational efficiency.

The following describes specific example embodiments with reference to the drawings, in greater detail. Note that the same reference numeral is assigned to the same constituting element, and explanation thereof will be omitted.

### The First Example Embodiment

The first example embodiment is explained in greater detail with reference to the drawings.

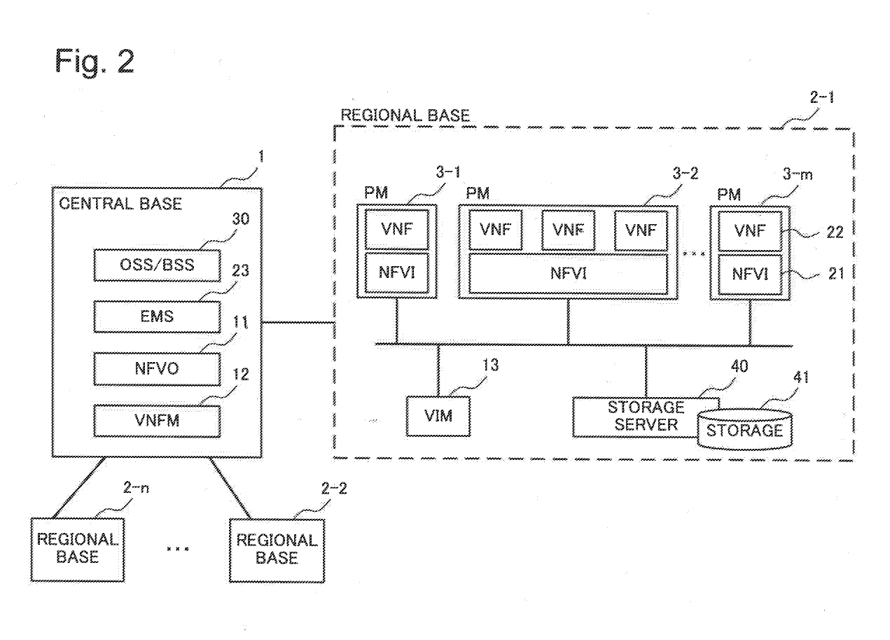

FIG. 2 is a drawing illustrating an exemplary schematic configuration of a network system according to the first example embodiment. Referring to FIG. 2, a central base 1 and a plurality of regional bases 2-1 to 2-n (n being a positive integer; the same applies hereinafter) are included in the network system. The central base 1 and the plurality of regional bases 2-1 to 2-n are connected via a network.

The central base 1 includes a server in which each functional entity such as an OSS/BSS 30, an EMS 23, a NFVO 11, and a VNFM 12 is installed. Each regional base 2-1 to 2-n includes a plurality of physical machines 3-1 to 3-m (m being a positive integer; the same applies hereinafter), a server in which the VIM 13 is installed, and a storage server 40.

Note that, in the following explanation, when there is no particular reason to distinguish among the regional bases 2-1 to 2-n, they are simply referred to as “regional base 2”. Likewise, when there is no particular reason to distinguish among the physical machine 3-1 to 3-m, they are simply referred to as “physical machine 3.

At least one virtual machine can be generated in a physical machine 3 included in the regional base 2. On the virtual machine, a VNF 22 is instantiated.

The storage server 40 is a server that manages a storage 41 made up of a hard disk drive (HDD) or the like. A data read or write request to the storage server 40 is also performed from an apparatus (e.g., EMS 23, NFVO 11, or VNFM 12) included in the central base 1, not only from an apparatus (e.g., VIM 13) included in the regional base 2. In addition, the storage 41 is constructed to be accessible from the physical machine 3 included in the regional base 2.

A so-called Boot From Cinder Volume is realized by making at least a part of the storage 41 accessible from the physical machine 3. For details of the Boot From Cinder Volume, the following literatures, or the like, can be referred to.

Reference literature: “Instance launch from volume” [online] on the Internet (https://docs.openstack.org/ja/user-guide/cli_nova_launch instance from volume.html)

So as to realize the Boot From Cinder Volume in VNF 22 instantiation, a virtual node, a root disk of which is mounted on a predetermined area (area determined in advance) on the storage 41, is generated.

The VNFM 12 and the VIM 13 request the storage server 40 to deploy, in a predetermined area of the storage 41, an image file required for instantiation of the VNF 22 so as to realize the above-mentioned Boot From Cinder Volume. In this way, the network system according to the first example embodiment adopts a Boot From Cinder Volume in instantiation of the VNF 22. In the network system, a resource (external storage not allocated to the virtual machine) different from the hardware resource that can be allocated to the virtual machine exists. Then, an image file is transferred onto the storage 41 being the external storage.

### [Hardware Configuration]

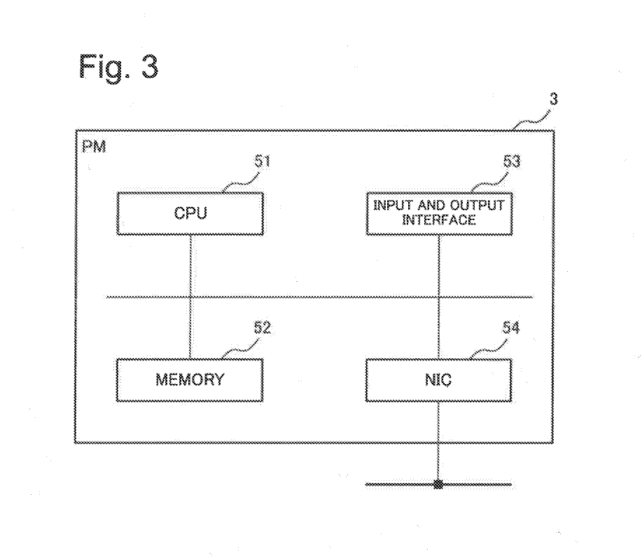

FIG. 3 is a block diagram illustrating an exemplary hardware configuration of the physical machine 3 according to the first example embodiment. The physical machine 3 is a so-called information processing apparatus (computer), and has a configuration as exemplified in FIG. 3. For example, the physical machine 3 has the following configurations to be mutually connected via an internal bus. That is, the configurations are a central processing unit (CPU) 51, a memory 52, an input and output interface 53, a network interface card (NIC) 54 being a communication unit, and the like.

Note that the configuration illustrated in FIG. 3 is not intended to limit the hardware configuration of the physical machine 3. The physical machine 3 may include hardware not illustrated in the drawings. Also note that the number of CPU 51 or the like included in the physical machine 3 is not intended to be limited to the illustration in FIG. 3. For example, a plurality of CPUs 51 may be included in the physical machine 3.

The memory 52 is a random access memory (RAM), a read only memory (ROM), and/or an auxiliary storage (hard disk or the like).

The input and output interface 53 is a unit that serves as an interface between a display and an input apparatus, which are not illustrated in the drawings. An example of the display is a liquid crystal display. An example of the input apparatus is an apparatus to receive user operation, such as a keyboard and a mouse.

Note that a hardware configuration of the other servers included in the central base 1 and the regional base 2 is basically the same as the configuration of the above-explained physical machine 3. Since the configuration is obvious for a person skilled in the art of the invention, explanation thereof is omitted.

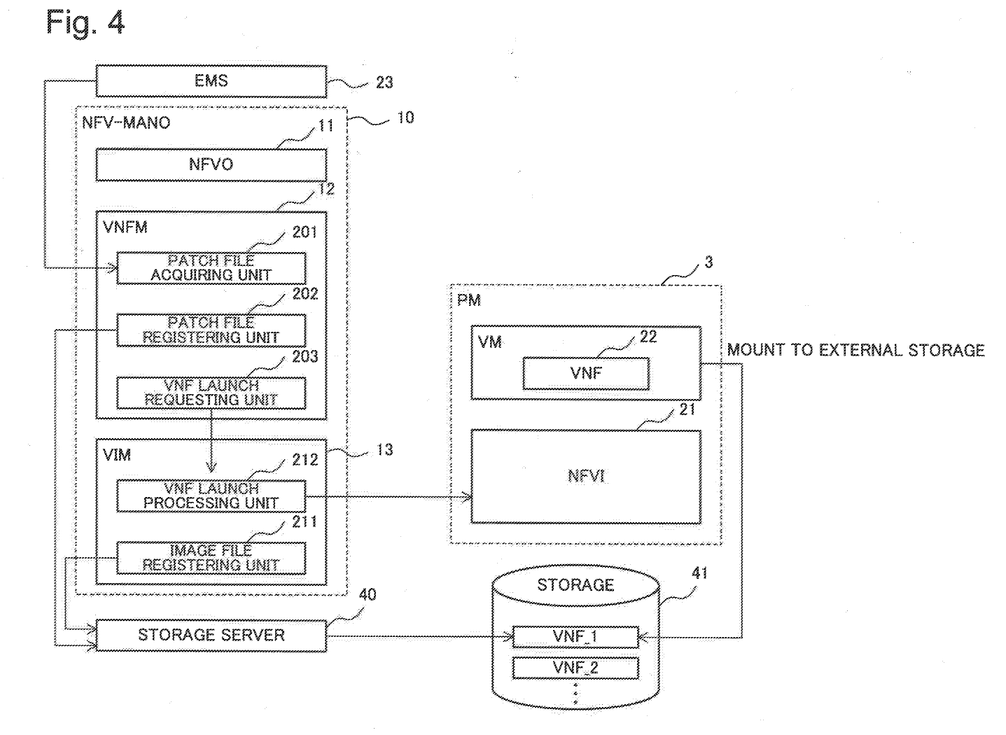

FIG. 4 is a block diagram for explaining functions of the network system according to the first example embodiment. Referring to FIG. 4, the VNFM 12 and the VIM 13 have functions (functional block) illustrated in FIG. 4, in addition to the functions described in 1 NPLs 1 and 2.

Specifically, the VNFM 12 includes a patch file acquiring unit 201, a patch file registering unit 202, and a VNF launch requesting unit 203.

The patch file acquiring unit 201 is a unit that acquires a patch file to be applied to the VNF 22, from an external apparatus (e.g., EMS 23). Note that as stated above, the image file to be used in instantiation of the VNF 22 includes program data related to an OS, MW, and an application (APL). However, a patch file is assumed to include only program data that is related to an application. Nonetheless, this is not intended to limit program data included in a patch file; and when applying a patch to a program related to an OS, for example, all or a part of the program data related to the OS may be included in the patch file.

The patch file registering unit 202 transmits, to the storage server 40, a patch file acquired by the patch file acquiring unit 201. In addition, the patch file registering unit 202 instructs the storage server 40 to rewrite an area for an application program of an image file stored in a predetermined area of the storage 41, based on the patch file. Note that determination (instruction to the storage server 40) on which area in the storage 41 to rewrite by a patch file can be determined based on later-described VNF deployment place address information provided by the VIM 13 and content of the patch file.

For example, in FIG. 4, when an image file for VNF_1 is stored in a predetermined area of the storage 41, the following situation results. That is, in the above-mentioned VNF deployment place address information, information in which an identifier of the VNF_1 is associated with a top address of an area in which the image file for the VNF_1 is stored is included. In addition, when a patch file is intended to rewrite an application (APL), the patch file registering unit 202 can comprehend an address of an application (APL) program in the image file, in advance. The VNFM 12 acquires an address in which the image file of the VNF_1 to which a patch is applied is stored, from the VNF deployment place address information. Then, the VNFM 12 instructs the storage server 40 to overwrite the patch file from an address to which a predetermined offset (offset calculated from an address related to the application program) is added to that address.

The VNF launch requesting unit 203 is a unit that requests the VIM 13 to launch the VNF 22 by using the image file after being applied the patch file. For example, in the above-described example, when a patch is applied to the image file of the VNF_1 in the storage 41, the VNF launch requesting unit 203 requests the VIM 13 to launch the VNF_1 by designating the address in which the image file of the VNF_1 is stored.

The VIM 13 includes an image file registering unit 211 and a VNF launch processing unit 212.

The image file registering unit 211 is a unit that registers an image file of the VNF 22 provided by the NFVO 11, to a predetermined area of the storage 41. Specifically, the image file registering unit 211 provides the storage server 40 with the image file and requests storage of the file in the storage 41. The storage server 40 stores the image file in the storage 41, and replies to the VIM 13 (image file registering unit 211), with the address in which the image file is stored. The image file registering unit 211 generates VNF deployment place address information by associating an identifier for the VNF 22 registered in the storage 41 and the above-mentioned address acquired form the storage server 40. The image file registering unit 211 distributes the generated VNF deployment place address information to such entity or module, such as the VNFM 12, which requires the information.

Note that registration of an image file to the storage 41 by the patch file registering unit 202 and the image file registering unit 211 is analogous to provision of an image file to the NFVI 21. This is because a predetermined area (area in which an image file is stored) in the storage 41 is configured to be accessible by each physical machine 3 (NFVI 21).

The VNF launch processing unit 212 is a unit that processes a VNF launch request received from the above-described VNFM 12.

Specifically, the VNF launch processing unit 212 generates and launches the VNF 22 by using an image file after being applied a patch file, by designating the address in the storage 41.

### [Operation of Network System]

Next, an operation of the network system according to the first example embodiment is explained with reference to the drawings.

First, instantiation of the VNF 22 at initial launch of the network system is explained.

At initial launch of the network system, processes of “VNF on-board” and “VNF instantiation” are included. The network system according to the first example embodiment performs an operation in accordance with the sequence described in “B.2.1 On-Board VNF Package Flow” on page 104 of NPL 1, in relation to the “VNF on-board”. In addition, in relation to “VNF instantiation”, the network system performs operation in accordance with the sequence described in “B.3.2.2 VNF instantiation from NFVO” on page 116 of same literature.

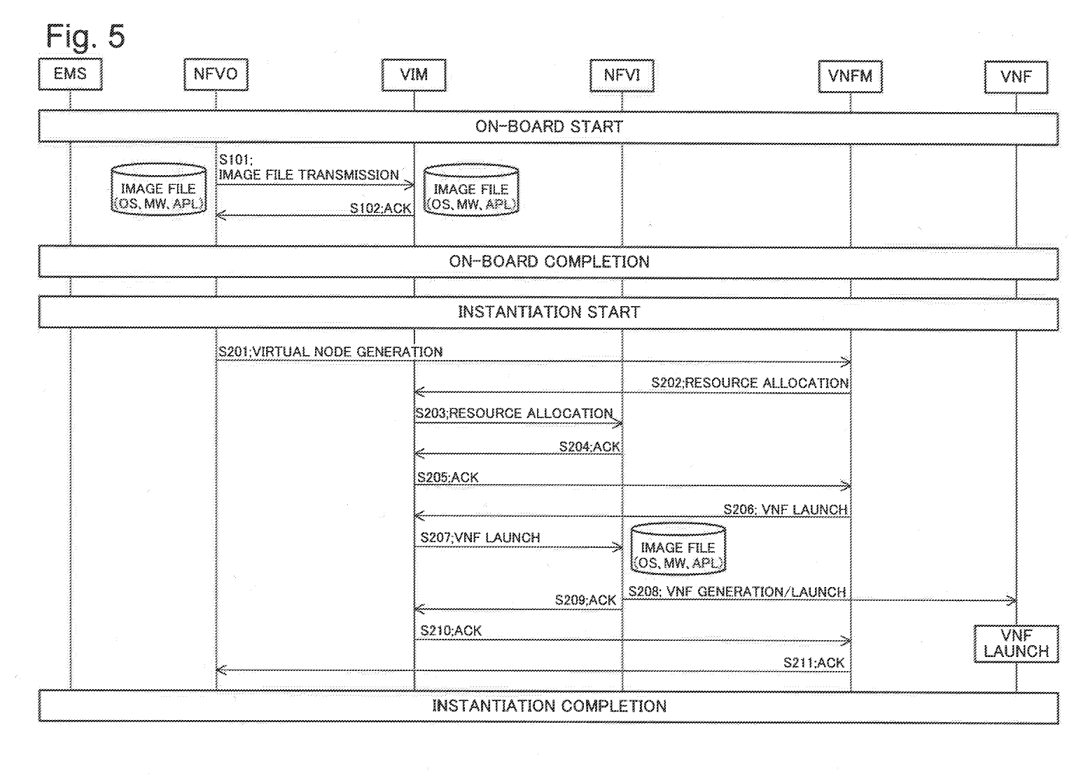

Here, an overview of the above-described two sequences is explained, with reference to FIG. 5. Note that the image file illustrated in FIG. 5 is a file that contains program data related to the OS, the MW, and the APL.

The NFVO 11 transmits the image file acquired from the EMS 23, for example, to the VIM 13 (Step S101).

Upon storing the image file in an image repository, the VIM 13 transmits an acknowledgement (ACK) to the NFVO 11 (Step S102). When the image file is stored in the image repository, the on-board processing of the VNF 22 completes.

In starting VNF instantiation, the NFVO 11 requests the VNFM 12 to generate a virtual node (Step S201).

Upon receiving the request, the VNFM 12 requests the VIM 13 to allocate resources (Step S202).

The VIM 13 performs the requested resource allocation (Step S203). Specifically, the VIM 13 generates and launches a network resource related to a virtual machine, in the deployment place of the virtual machine. When the launch is normally ended (reception of the acknowledgement (ACK) in Step S204), the VIM 13 transmits an acknowledgement (ACK) for the resource allocation request, to the VNFM 12 (Step S205).

Thereafter, the VNFM 12 requests the VIM 13 to launch the VNF 22 (Step S206). Upon receiving the request, the VIM 13 launches the VNF 22 by setting a unique parameter to the deployment after storing the image file in a predetermined area of the storage 41 (Step S207). Specifically, the VIM 13 sets, to a virtual machine to which resource allocation is completed, a parameter that includes an address for a predetermined area of the storage 41 in which the image file for the VNF 22 to be performed instantiation is stored.

Based on the setting of the above-mentioned unique parameter, generation and launch of the VNF 22 from the above-mentioned predetermined area of the storage 41 are performed (Step S208). When the launch of the VNF 22 is normally ended, an acknowledgement (ACK) is transmitted from the NFVI 21 to the VIM 13 (Step S209).

Upon receiving the acknowledgement (ACK), the VIM 13 transmits an acknowledgement (ACK) for the VNF launch request in Step S206, to the VNFM 12 (Step S210). Upon receiving the acknowledgement (ACK), the VNFM 12 transmits an acknowledgement (ACK) for a virtual node generation request in Step S201, to the NFVO 11 (Step S211).

By the above-described steps, instantiation of the VNF 22 completes.

Next, an operation related to update of the VNF 22 is explained.

Update of the VNF 22 is realized by applying a patch to an image file of the VNF 22. Update of the VNF 22 is configured by two processes of registration of a patch file and application of the patch file. Registration of a patch file is performed by using the EMS 23 or the like. Various types of triggers may be conceived of as a trigger to start application of a patch file. However, in the first example embodiment, a trigger is explained as a trigger for application of a patch file to heal the VNF 22, when a fault occurs in the VNF 22 during operation. However, this is not intended to limit the trigger related to update of the VNF 22 to healing of the VNF 22. For example, update of the VNF 22 may be performed when scaling-out of the VNF 22.

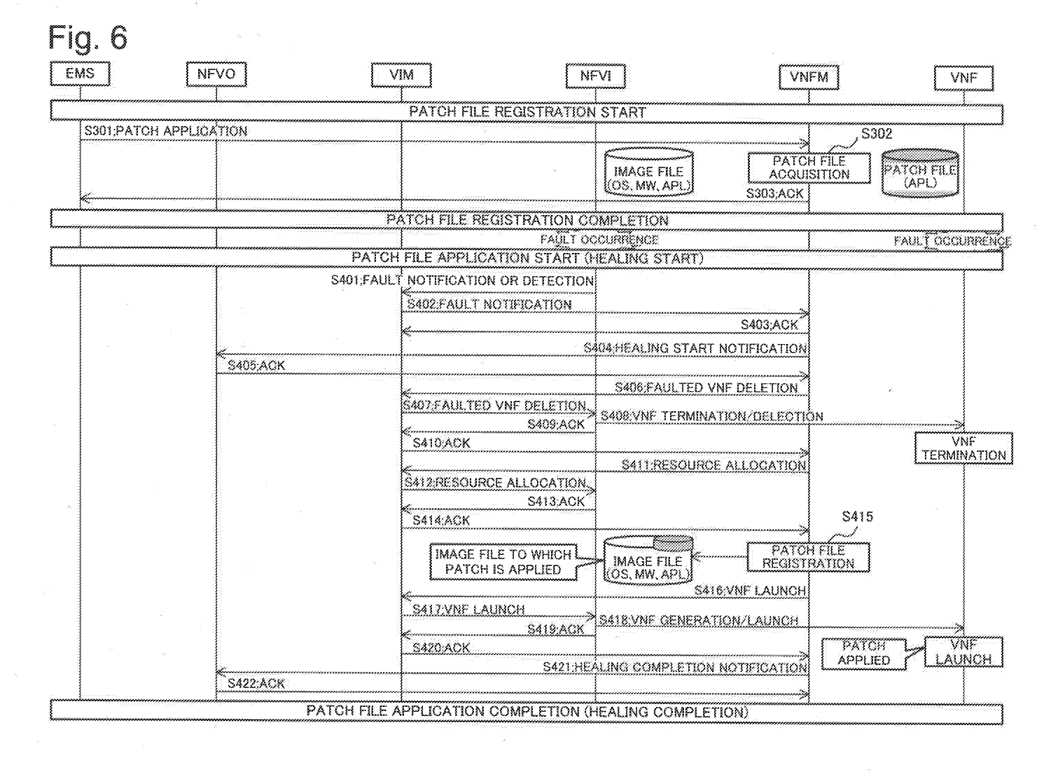

FIG. 6 is a sequence diagram illustrating an exemplary operation of a network system, concerning update of the VNF 22.

In Step S301, the EMS 23 requests the VNFM 12 to apply a patch file. At that time, the EMS 23 provides the VNFM 12 with a patch file (image file for patch), by designating the VNF 22 to which a patch is applied (together with an identifier of the VNF 22).

After acquiring the patch file (Step S302) and storing the patch file in a recording medium such as a HDD, the VNFM 12 transmits an acknowledgement (ACK) to the EMS 23 (Step S303).

In the above-described steps, registration of a patch file completes.

Note that at a time when a patch file is registered, an image file used by the VNF 22 during operation is stored in a predetermined area of the storage 41. In other words, the VNF 22 to which a patch is to be applied is operated in accordance with the image file stored in the predetermined area of the storage 41.

If a fault occurs either in the VNF 22 during operation or in the NFVI 21, in the state in which registration of the patch file is complete, healing of the VNF 22 starts.

In Step S401, the VIM 13 detects occurrence of a fault (detect a fault) in the VNF 22 during operation.

The VIM 13 notifies the VNFM 12 of occurrence of the fault in the VNF 22 (Step S402).

The VNFM 12 transmits, to the VIM 13, an acknowledgement (ACK) for the notification (Step S403), and notifies the NFVO 11 that the VNFM 12 intends to start healing of the VNF 22 (Step S404).

Upon receiving the acknowledgement (ACK) for the notification, from the NFVO 11 (Step S405), the VNFM 12 issues a request to delete the VNF 22 in which the fault occurs, to the VIM 13 (Step S406).

Upon receiving the request, VIM 13 deletes (terminates) the VNF 22 in which the fault occurs (Step S407).

Upon deletion (termination) of the VNF 22 in which the fault occurs (Step S408), an acknowledgement (ACK) is transmitted to the VIM 13 (Step S409).

Upon receiving the acknowledgement (ACK) described above, the VIM 13 issues, to the VNFM 12, an acknowledgement (ACK) for the request to delete the VNF 22 issued in Step S406 (Step S410).

Next, the VNFM 12 issues a resource allocation request to the VIM 13 (Step S411).

The VIM 13 performs the requested resource allocation (Step S412). Specifically, the VIM 13 generates and launches a network resource related to a virtual machine in the deployment place of the virtual machine. When the launch is normally ended (reception of the acknowledgement (ACK) in Step S413), the VIM 13 transmits an acknowledgement (ACK) for the resource allocation request, to the VNFM 12 (Step S414).

The VNFM 12 received the acknowledgement (ACK) instructs the storage server 40 to rewrite a part of the matching image file by using a patch file (an image file for patch) acquired in a patch file registering process. That is, the VNFM 12 received the acknowledgement (ACK) registers the patch file in the storage 41 (Step S415). Thereafter, the VNFM 12 requests the VIM 13 to launch the VNF 22 by patch application (Step S416). Specifically, the VNFM 12 designates the VNF 22 to apply a patch, and requests the VIM 13 to launch the VNF 22.

The VIM 13 sets a parameter unique to a deployment including an address for a predetermined area of the storage 41 in which the image file for the VNF 22 to apply a patch is stored, to a virtual machine to which a resource is allocated. Upon this operation, the VIM 13 executes launch of the VNF 22 by patch application (Step S417).

Based on setting of the above-mentioned unique parameter, generation and launch of the VNF 22 from the above-mentioned predetermined area of the storage 41 are performed (Step S418). When launch of the VNF 22 is normally ended, an acknowledgement (ACK) is transmitted from the NFVI 21 to the VIM 13 (Step S419).

The VIM 13 received the acknowledgement (ACK) transmits, to the VNFM 12, an acknowledgement (ACK) for the request to launch the VNF 22 by patch application in Step S416 (Step S420).

The VNFM 12 transmits a healing completion notification to the NFVO 11 (Step S421), and receives the acknowledgment (ACK) from the NFVO 11 (Step S422), thereby completing the healing processing.

Note that the configuration and the operation of the network system explained in the above-described example embodiment are exemplary, and do not intend to limit a configuration of the system. For example, the above-described example embodiment is explained by way of a case in which the VNFM 12 registers a patch file in the storage 41. However, the patch file may be registered in the storage 41 from the EMS 23 or the NFVO 11. That is, any configuration may be used as long as any one of the EMS 23, the NFVO 11, and the VNFM 12 provides the NFVI 21 with a patch file to be used in updating the VNF 22 (the NFVI 21 is provided with the patch file without passing through the VIM 13).

In addition, in the above-described example embodiment, a case in which the Boot From Cinder Volume is used in instantiation of the VNF 22. However, the above-described example embodiment does not necessarily have to adopt this method. In such a case, any one of the EMS 23, the NFVO 11, and the VNFM 12 may provide the NFVI 21 with a patch file and rewrite allocated area of the storage, which the NFVI 21 allocates to the virtual machine. In other words, any one of the EMS 23, the NFVO 11, and the VNFM 12 may directly provide the NFVI 21 with a patch file used for updating of the VNF 22, without passing through the storage server 40 (storage 41).

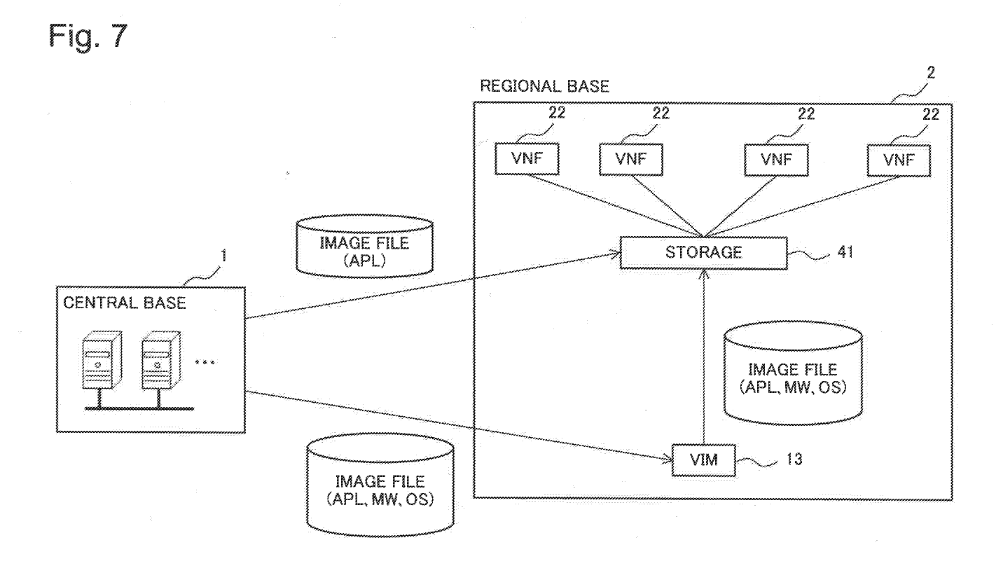

As described above, at major update including a case of OS change, the network system according to the above-described example embodiment expands an image file including program data such as an OS, MW, or an APL onto the VNF 22 by passing through the VIM 13, as illustrated in FIG. 5. On the other hand, as illustrated in FIG. 6, the network system according to the above-described example embodiment operates as follows, at minor update including patch application which is frequently performed. That is, the network system expands a partial (e.g., only application data) image file (patch file) of a small size, which is limited to a portion to which a patch is applied, directly onto the VNF 22 from an apparatus (e.g., the EMS 23 or the VNFM 12) in the central base 1. FIG. 7 illustrates a transfer path on which an image file is transferred at major update and at minor update.

By directly expanding the patch file onto the VNF 22 from an apparatus of the central base 1, a small-sized image file is transferred without passing through an apparatus (server in which the VIM 13 is installed). Therefore, the network system can shorten the time required for healing of the VNF 22, which can be caused in the network system. That is, according to the first example embodiment, an efficient operation of the network system is realized, because a small-sized file transfer, which is frequently performed, can be realized without passing through the VIM 13.

In addition, according to the first example embodiment, the Boot From Cinder Volume is used to realize instantiation of the VNF 22. Therefore, the first example embodiment does not have to directly transfer an image file to the physical machine 3 (NFVI 21), but may transfer the image file to an external storage, which achieves efficient instantiation of the VNF 22. Note that merely by adopting the Boot From Cinder Volume and expanding a patch file onto the VNF 22 by passing through the VIM 13, such efficient operation of the network system cannot be achieved. This is because even when adopting the technique, expansion of the image file onto all the regional bases 2 from the central base 1 is still necessary.

In addition, launch of the VNF 22 using a patch file is not described in NPL1. What is described in NPL1 is merely that when updating the VNF 22, VIM 13 is provided with an image file including an OS, MW, or an APL, and the VNF 22 is launched (instantiated). (For example, please refer to “B.2.4 Update VNF Package flow” on page 106 of this reference.)

The processing performed by each apparatus as illustrated in FIG. 4 or the like can be realized based on a computer program, where the computer program is executed by a computer mounted on each apparatus thereby executing each process described above, by using its hardware. That is, a part or all of each unit may be realized based on a program executed on a computer (processor or the like), and may be any unit that executes a function performed by each processing module described above, by way of any hardware and/or software.

An industrial applicability of the present invention is obvious, based on the description above. The present invention can be preferably applied to a system that has to secure, in advance, resources required for a system that has to operate 24 hours without halt to cause no effect on end users, just as at the time of non-virtualization, such as a virtualized communication server (VNF 22). The present invention can also be preferably applied to a system in which various types of virtual servers (VNF 22) require maintenance simplification and scenario execution.

The whole or part of the exemplary embodiments disclosed above can be described as, but not limited to, the following supplementary notes.

[Supplementary Note 1]

As a network system according to the first aspect described above.

[Supplementary Note 2]

The network system according to supplementary note 1, further includes:

a virtualized infrastructure manager (VIM) that performs resource management and control on the NFVI, wherein

the any one of the EMS, the NFVO, and the VNFM that provides the NFVI with the patch file provides the NFVI with the patch file without passing through the VIM.

[Supplementary Note 3]

The network system according to supplementary note 2, wherein

the NFVO provides the VIM with an image file that is a file used for instantiation of the VNF, and includes program data related to an operating system, middleware or an application, and

the VIM provides the NFVI with the image file.

[Supplementary Note 4]

The network system according to supplementary note 3, further includes:

a storage server that manages a storage that is accessible from outside, wherein

the VIM provides the storage server with the image file,

the storage server stores the image file provided, in a predetermined area of the storage, and

the VIM launches the VNF by using the image file stored in the predetermined area of the storage.

[Supplementary Note 5]

The network system according to supplementary note 4, wherein

the any one of the EMS, the NFVO, and the VNFM that provides the NFVI with the patch file instructs the storage server to rewrite a part of the predetermined area in which the image file is stored, with the patch file.

[Supplementary Note 6]

The network system according to supplementary note 5, wherein

after ending of the rewriting of a part of the image file based on the patch file, the VNFM request the VIM to launch the VNF by using the image file, a part of which is rewritten.

[Supplementary Note 7]

The network system according to supplementary note 6, wherein

when healing the VNF, a part of the image file is rewritten based on the patch file, and the VNF is launched by using the image file, a part of which is rewritten.

[Supplementary Note 8]

The network system according to any one of supplementary notes 3 to 7, wherein

the patch file includes program data related to an application, from among the program data included in the image file.

[Supplementary Note 9]

As a patch file application method according to the second aspect described above.

[Supplementary Note 10]

As a program according to the third aspect described above.

Note that the embodiments of Supplementary note 9 and Supplementary note 10 can be, just as the embodiment of Supplementary note 1, developed into the embodiments of Supplementary note 2 to Supplementary note 8.

Each disclosure of patent literatures or the like as cited above is incorporated herein by reference. The example embodiments or examples can be changed or adjusted, within the scope of the entire disclosure (including the scope of claims) of the present invention and based on its basic technical idea. In addition, various disclosure elements (including each element in each claim, each element in each example embodiment or example, and each element of each drawing, and the like) in the scope of the entre disclosure of the present invention may be combined or selectively adopted in various ways. That is, it is needless to say that the present invention includes various modifications and alterations which a person skilled in the art of the invention could accomplish by relying on the entire disclosure including the scope of claims and its technical idea. In particular, the numerical range described herein shall be deemed in such a manner that any numerical value or sub-range included in that range is specifically described, even when there is no such description.

This application is based upon and claims the benefit of priority from Japanese patent application No. 2016-085053, filed on Apr. 21, 2016, the disclosure of which is incorporated herein in its entirety by reference.

### REFERENCE SINGS LIST

1 Central base
2, 2-1 to 2-n Regional base
3, 3-1 to 3-m Physical machine
10 NFV-MANO
11, 102 NFVO
12, 103 VNFM
13 VIM
21, 100 NFVI
22 VNF
23, 101 EMS
30 OSS/BSS
40 Storage server
41 Storage
51 CPU
52 Memory
53 Input and output interface
54 NIC
201 Patch file acquiring unit
202 Patch file registering unit
203 VNF launch requesting unit
211 Image file registering unit
212 VNF launch processing unit

What is claimed is:

1. A network system comprising:
a plurality of computers mutually connected via a network, the plurality of computers comprising,
a first computer that performs operations of an element management system (EMS) that relates to a virtual network function (VNF) installed and virtualized by software operating on a virtual machine;
a second computer that performs operations of a network function virtualization (NFV) orchestrator (NFVO) that realizes a network service a network function virtualization infrastructure (NFVI);
a third computer that performs operations of a VNF manager (VNFM) that manages a lifecycle of the VNF; and
a fourth computer that performs operations of the NFVI that provides an execution basis for the VNF, updates the VNF by using a patch file provided by at least any one of the EMS, the NFVO, and the VNFM and performs instantiation of the VNF by using the patch file.

2. The network system according to claim 1, the plurality of computers further comprising:
a fifth computer that performs operations of a virtualized infrastructure manager (VIM) that performs resource management and control on the NFVI, wherein
the any one of the EMS, the NFVO, and the VNFM that provides the NFVI with the patch file provides the NFVI with the patch file without passing through the VIM.

3. The network system according to claim 2, wherein
the NFVO provides the VIM with an image file that is a file used for instantiation of the VNF, and includes program data related to an operating system, middleware or an application, and
the VIM provides the NFVI with the image file.

4. The network system according to claim 3, further comprising:
a storage server that manages a storage that is accessible from outside, wherein
the VIM provides the storage server with the image file,
the storage server stores the image file provided, in a predetermined area of the storage, and
the VIM launches the VNF by using the image file stored in the predetermined area of the storage.

5. The network system according to claim 4, wherein
the any one of the EMS, the NFVO, and the VNFM that provides the NFVI with the patch file instructs the storage server to rewrite a part of the predetermined area in which the image file is stored, with the patch file.

6. The network system according to claim 5, wherein
after ending of the rewriting of a part of the image file based on the patch file, the VNFM request the VIM to launch the VNF by using the image file, a part of which is rewritten.

7. The network system according to claim 6, wherein
when healing the VNF, a part of the image file is rewritten based on the patch file, and the VNF is launched by using the image file, a part of which is rewritten.

8. The network system according to claim 3, wherein
the patch file includes program data related to an application, from among the program data included in the image file.

9. A patch file application method used in a network system including a plurality of computers, the patch file application method comprising:
performing operations of an element management system (EMS) for a virtual network function (VNF) installed and virtualized by software operating on a virtual machine;
performing operations of a network function virtualization (NFV) orchestrator (NFVO) that realizes a network service on a network function virtualization infrastructure (NFVI);
performing operations of a VNF manager (VNFM) that manages a lifecycle of the VNF; and
performing operations of the NFVI that provides an execution basis for the VNF, updates the VNF by using a patch file provided by at least any one of the EMS, the NFVO, and the VNFM and
performs instantiation of the VNF by using the patch file.

10. A non-transitory computer-readable recording medium embodying a program, the program causing a network system including a plurality of computers to performs a method, the method comprising:
performing operations of an element management system (EMS) for a virtual network function (VNF) installed and virtualized by software operating on a virtual machine;
performing operations of a network function virtualization (NFV) orchestrator (NFVO) that realizes a network service on a network function virtualization infrastructure (NFVI);
performing operations of a (VNF) manager (VNFM) that manages a lifecycle of the VNF; and
performing operations of the NFVI that provides an execution basis for the VNF, updates the VNF by using a patch file provided by at least any one of the EMS, the NFVO, and the VNFM and performs instantiation of the VNF by using the patch file.
